(19) United States
(12) Patent Application Publication
(10) Pub. No.: US 2013/0103530 A1
(43) Pub. Date: Apr. 25, 2013

(54) Online Auction System Having a Quick-Buy Mechanism and Method for Use Thereof

(71) Applicants: Shaun Tilford, Edmond, OK (US); Michael Morrison, (US)

(72) Inventors: Shaun Tilford, Edmond, OK (US); Michael Morrison, (US)

(21) Appl. No.: 13/277,951

(22) Filed: Oct. 20, 2011

(51) Int. Cl. G06Q 30/08

(52) U.S. Cl. 705/26.3

(57) ABSTRACT

An online auction system comprising a host system having at least one processor for executing processor executable code and at least one non-transitory memory communicating with the processor and storing processor executable code. The processor executable code, when executed by the at least one processor, causes the at least one processor to transmit a first signal via a network to a user terminal indicative of a first auction page for auctioning an item. The first auction page comprises a bid mechanism and a quick-buy mechanism capable of being selectively activated by the user terminal. The processor receives a quick-buy signal from the user terminal over the network indicative of an activation of the quick-buy mechanism, and in response to receiving the quick-buy signal, credits at least one bid to a user account without disrupting a capability of the bid mechanism to be selectively activated by the user terminal.

### CROSS-REFERENCE TO RELATED APPLICATIONS

Not Applicable.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The inventive concept(s) disclosed and claimed herein generally relates to online auctions, and more particularly, but not by way of limitation, to an online penny auction system allowing a user to buy bids without leaving the auction page.

Online auctions have existed in various forms since as early as the late 1970's, long before the advent of the World Wide Web, when primitive auctions were conducted on early Internet Bulletin Board Services. Modern online auctions began in 1995 with the launch of AuctionWeb, which would later become eBay®.

The penny auction industry was born in September 2005, when Telebid launched in Germany. Penny auctions are distinct from traditional online auctions in that bidders pay a participation fee for each bid placed. Telebid users were initially required to phone-in bids, but the site was later modified to allow users to place bids through a web browser. In 2008, Telebid changed its name to Swoopo and expanded to several other countries, including the U.S. and U.K. Many other penny auctions were soon launched in the U.S. and elsewhere, including QuiBids, BigDeal, BidCactus, BidRivals, and Beezid.

Some penny auctions are highly competitive auctions, where the end time is typically dynamically extended every time a user places a bid. The outcomes of penny auctions are dependent on user skill and bid timing, with more experienced users typically winning more auctions than novice users.

A unique feature of penny auctions is the so called “pay-to-bid” system, which requires users to buy a certain number of bids typically sold in various size packages (or “bid packs”), prior to being allowed to place one or more bids in an auction. This leads to a problem in the prior art that is unique to pay-to-bid auction systems—users running out of prepaid bids during an auction. Heretofore, if a user (or bidder) in a penny auction ran out of bids during an auction, they had to leave the auction page, and proceed to a different bid purchase page to buy one or more bids and/or bid packs. Once the user had completed the purchase, they were allowed to return to the auction, and continue bidding. Due to the highly competitive and dynamic nature of penny auctions, the auction may have ended in the time it took for the user to complete the purchase. Further, the user's determination and leading position in the auction may be compromised by the user's apparent inactivity as perceived by other participants in the auction.

A further shortcoming of prior art penny auction system is that once a user becomes engaged in bidding for one or more items, the user is typically unaware of the remaining number of bids in their account. Even with planning, an unexpectedly competitive auction may leave a user with zero bids in their account during a heated bidding battle, causing the user to scramble to leave the auction, buy bids, and return to the auction, prior to losing the item to another bidder.

To that end, a need exists in the prior art for an online penny auction system which allows a user to buy bids without leaving an auction they are bidding in. It is to such an online auction system that the instant inventive concept(s) is directed.

### SUMMARY

In one aspect, the inventive concept(s) disclosed herein is directed to an online auction system. The online auction system has a host system comprising at least one processor for executing processor executable code and at least one non-transitory memory communicating with the at least one processor and storing processor executable code. The processor executable code, when executed by the at least one processor, causes the processor to transmit a first signal via a network to a user terminal indicative of a first auction page for auctioning an item. The first auction page comprises a bid mechanism and a quick-buy mechanism capable of being selectively activated by the user terminal. The processor receives a quick-buy signal from the user terminal over the network indicative of an activation of the quick-buy mechanism, and in response to receiving the quick-buy signal, credits at least one bid to a user account, without disrupting a capability of the bid mechanism to be selectively activated by the user terminal.

In another aspect, the instant inventive concept(s) is directed to an online auction system comprising a host system having at least one processor for executing processor executable code and at least one non-transitory memory communicating with the at least one processor and storing processor executable code and a user's account comprising a number of bids. The processor executable code, when executed by the at least one processor, causes the at least one processor to (a) transmit a first signal over a network to a user terminal indicative of a first auction page for auctioning one or more items, the first auction page comprising one or more bid mechanisms and a quick-buy mechanism; (b) receive a bid signal from the user terminal over the network indicative of an activation of at least one of the one or more bid mechanisms by the user terminal; (c) in response to receiving the bid signal deduct a bid from the user's account; (d) in response to the number of bids remaining in the user account reaching a pre-set number, transmit a second signal over the network to the user terminal indicative of the number of bids remaining in the user account reaching the pre-set number; (e) receive a quick-buy signal from the user terminal over the network indicative of an activation of the quick-buy mechanism by the user terminal; and (f) in response to receiving the quick-buy signal, credit at least one bid to the user account, without disrupting the capability of at least one of the one or more bid mechanisms of being selectively activated by the user terminal.

In yet another aspect, the instant inventive concept(s) is directed to an online auction system comprising a host system having at least one processor for executing processor executable code and at least one non-transitory memory communicating with the at least one processor. The memory stores processor executable code and a user's account comprising a number of bids. The processor executable code when executed by the at least one processor, causes the at least one processor to: (a) transmit a first signal to a network indicative of a first auction page for auctioning an item, the first auction page comprising an auction price, a bid mechanism capable of being selectively activated by a user terminal, and a quick-buy mechanism capable of being selectively activated by the user terminal; (b) receive a second signal from the user terminal over the network indicative of an activation of the bid mechanism by the user terminal; (c) receive a third signal from the user terminal over the network indicative of an activation of the quick-buy mechanism by the user terminal; (d) in response to receiving the second signal, raise the auction price by a preset amount and deduct a bid from the user's account, without disrupting the capability of the quick-buy mechanism of being activated by the user terminal, such that the quick-buy mechanism remains at least partially visible to the user during the activation of the bid mechanism; (e) in response to receiving the third signal, credit at least one bid to the user's account, without disrupting the capability of the bid mechanism of being activated by the user terminal, such that the bid mechanism remains at least partially visible to the user during the activation of the quick-buy mechanism; and (f) transmit a fourth signal over the network to the user terminal, indicative of a raised auction price and an amount of bids remaining in the user's account.

In yet another aspect, the instant inventive concept(s) is directed to an online auction system comprising a host system having at least one processor executing processor executable code and at least one non-transitory memory communicating with the at least one processor and storing processor executable code and a user's account comprising a number of bids. The processor executable code when executed by the at least one processor, causes the at least one processor to: (a) transmit a first signal over a network to a user terminal indicative of a first auction page for auctioning one or more items, the first auction page comprising one or more bid mechanisms capable of being selectively activated by the user terminal; (b) receive a bid signal from the user terminal over the network indicative of an activation of the bid mechanism by the user terminal; (c) in response to receiving the bid signal deduct a bid from the user's account; (d) in response to the number of bids remaining in the user's account reaching a pre-set number, transmit a second signal over the network to the user terminal indicative of the first auction page comprising a quick-buy mechanism capable of being activated by the user; (e) receive a quick-buy signal from the user terminal over the network indicative of the activation of the quick-buy mechanism by the user terminal; and (f) in response to receiving the quick-buy signal, credit at least one bid to the user's account, without disrupting the capability of at least one of the one or more bid mechanisms of the first auction page of being activated by the user terminal.

In yet another aspect, the instant inventive concept(s) is directed to an online auction system comprising a host system having at least one processor executing processor executable code and at least one non-transitory memory communicating with the at least one processor and storing processor executable code. The processor executable code when executed by the at least one processor, causes the at least one processor to: (a) transmit a first signal via a network to a user terminal indicative of a first auction page for auctioning an item, the first auction page comprising a bid mechanism and an information bar having a quick-buy mechanism capable of being selectively activated by the user terminal; (b) receive a quick-buy signal from the user terminal over the network indicative of an activation of the quick-buy mechanism; and (c) in response to receiving the quick-buy signal, sell at least one bid to a user of the user terminal, without disrupting the capability of the bid mechanism of being selectively activated by the user terminal.

### BRIEF DESCRIPTION OF THE SEVERAL VIEWS OF THE DRAWINGS

Like reference numerals in the figures represent and refer to the same or similar element or function. Implementations of the disclosure may be better understood when consideration is given to the following detailed description thereof. Such description makes reference to the annexed pictorial illustrations, schematics, graphs, drawings, and appendices. In the drawings:

FIG. 1 is a schematic diagram of an embodiment of an online auction system according to the instant inventive concept(s).

FIG. 2 is a block diagram of an embodiment of a memory according to the instant inventive concept(s).

FIG. 3 is an exemplary embodiment of a method of registering users according to the instant inventive concept(s).

FIG. 4 is an exemplary embodiment of an auction page according to the instant inventive concept(s).

FIG. 5A an exemplary embodiment of an auction page according to the instant inventive concept(s) having an information bar.

FIG. 5B is the auction page of FIG. 5A with a profile information portion of the information bar shown expanded.

FIG. 5C is the auction page of FIG. 5A with an account portion of the information bar shown expanded.

FIG. 5D is the auction page of FIG. 5A with a quick-buy portion of the information bar shown expanded.

FIG. 5E is the auction page of FIG. 5A with a connection meter portion of the information bar shown expanded.

FIG. 5F is the auction page of FIG. 5A with an auction watchlist portion of the information bar shown expanded.

FIG. 5G is the auction page of FIG. 5A with a notifications portion of the information bar shown expanded.

FIG. 6A is an exemplary embodiment of an auction page having an information bar according to the instant inventive concept(s).

FIG. 6B is the auction page of FIG. 6A with a quick-buy portion of the information bar shown expanded.

### DETAILED DESCRIPTION OF INVENTIVE CONCEPT(S)

Before explaining at least one embodiment of the inventive concept(s) disclosed herein in detail, it is to be understood that the inventive concept(s) is not limited in its application to the details of construction and the arrangement of the components or steps or methodologies set forth in the following description or illustrated in the drawings. The inventive concept(s) disclosed herein is capable of other embodiments or of being practiced or carried out in various ways. Also, it is to be understood that the phraseology and terminology employed herein is for the purpose of description and should not be regarded as limiting the inventive concept(s) disclosed and claimed herein in any way.

In the following detailed description of embodiments of the inventive concept(s), numerous specific details are set forth in order to provide a more thorough understanding of the inventive concept(s). However, it will be apparent to one of ordinary skill in the art that the inventive concept(s) within the disclosure may be practiced without these specific details. In other instances, well-known features have not been described in detail to avoid unnecessarily complicating the instant disclosure.

The inventive concept(s) disclosed herein is generally directed to an online auction system which allows a user to buy bids without leaving an auction they are bidding in. The online auction system will be described hereinafter in the context of penny auctions, but it is to be understood that the instant inventive concept(s) is equally applicable to other types of auctions, as will be understood by a person of ordinary skill in the art presented with the instant disclosure.

As used herein, the terms “network-based,” “cloud-based” and any variations thereof, are intended to cover the provision of configurable computational resources on demand via interfacing with a computer network, with software and/or data at least partially located on the computer network, by pooling the processing power of two or more networked processors, for example.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed.

As used herein the notation “a-n” appended to a reference numeral is intended as merely convenient shorthand to reference one, or more than one, and up to infinity, of the element or feature identified by the respective reference numeral (e.g., 134a-n). Similarly, a letter following a reference numeral is intended to reference an embodiment of the feature or element that may be similar, but not necessarily identical, to a previously described element or feature bearing the same reference numeral (e.g., 148, 148a, 148b, etc.). Such shorthand notations are used for purposes of clarity and convenience only, and should not be construed to limit the instant inventive concept(s) in any way, unless expressly stated to the contrary.

As used in the instant disclosure the terms “provide,” “providing” and variations thereof comprise displaying or providing for display an auction page to one or more user terminals interfacing with a computer network and/or allowing the one or more user terminals to participate in an auction, such as by interacting with one or more mechanisms on an auction page, in order to view the auctioned item and/or place a bid on the item, and/or purchase the auctioned item, by sending and/or receiving digital or optical signals via a computer network interface (e.g. an Ethernet port, a TC/IP port, an optical port, a cable modem, and combinations thereof) for example. A user may be provided with an auction page in a web browser, or in a local software application running on a user terminal 104, for example.

As used herein the term “bid mechanism” and any variations thereof comprises a feature of the graphical user interface, or a feature of a software application, allowing a user to indicate to a host system that the user wishes to place a bid in an auction, such as by interfacing with the host system over a computer network and exchanging digital or optical signals with the host system using a network protocol, for example. Such bid mechanism may be implemented with computer executable code executed by at least one processor, for example, with a button, a hyperlink, an icon, a clickable symbol, and combinations thereof, that can be activated by a user terminal interfacing with the at least one processor over a computer network, for example.

As used herein the term “bid signal” refers to a signal that indicates that a user wishes to place a bid in an online auction. A bid signal can be generated and transmitted to a host system over a network by a user terminal responsive to a selection of the bid mechanism.

As used herein the term “quick-buy mechanism” and any variations thereof comprises a feature of the graphical user interface or a feature of a software application, allowing a user to indicate to a host system that the user wishes to buy one or more bids such as by interfacing with the host system over a computer network and exchanging digital or optical signals with the host system using a network protocol, for example. Such quick-buy mechanism may be implemented, for example, as a button, a hyperlink, an icon, a clickable symbol, and combinations thereof, that can be activated by a user terminal interfacing with the at least one processor of a host system over a computer network, for example. Such quick-buy mechanism may be available to users regardless of any bids placed by the users, for example, or may be available to users on fulfillment of a predetermined condition such as submitting a predetermined number of bids, or having a preset number of bids remaining in their account.

As used herein the term “quick-buy signal” refers to a signal that indicates that a user has activated the quick-buy mechanism and wishes to buy one or more bids or bid packs. A quick-buy signal can be generated and transmitted to a host system over a network by a user terminal responsive to activation of the quick-buy mechanism by a user.

As used herein the terms “item,” “items” and variations thereof are not limited to tangible items, and may include services, bids, bid packs, coupons, subscriptions, virtual items, virtual currencies, and combinations thereof, for example.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept(s). This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

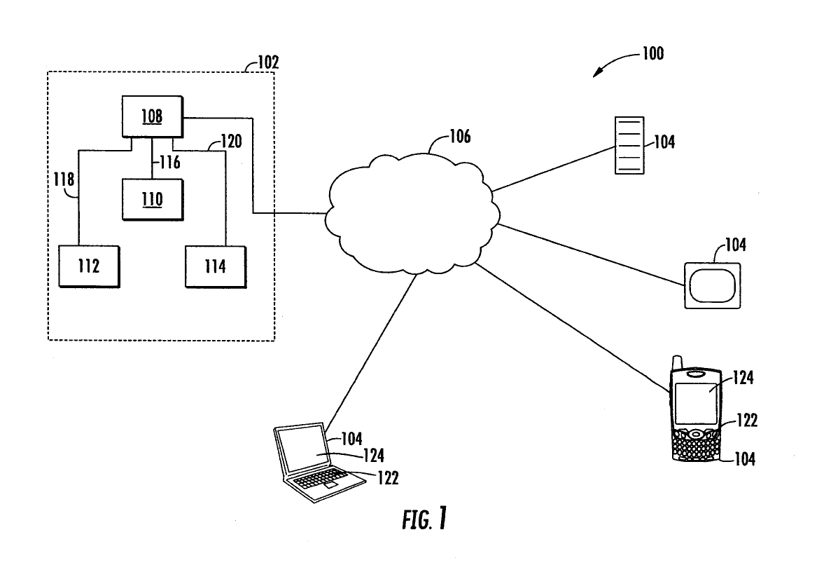

Referring now to FIG. 1, shown therein is an exemplary embodiment of an online auction system 100 according to the instant disclosure. The online auction system 100 comprises one or more host systems 102 capable of interfacing and/or communicating with one or more user terminals 104 over a network 106.

The one or more host systems 102 comprise one or more processors 108 capable of executing processor executable code, one or more non-transitory memory 110 capable of storing processor executable code, an input device 112, and an output device 114, all of which can be partially or completely network-based or cloud-based, and not necessarily located in a single physical location.

The one or more processors 108 can be implemented as a single processor 108 or multiple processors 108 working together to execute the logic described herein. Exemplary embodiments of the one or more processor 108 include a digital signal processor (DSP), a central processing unit (CPU), a field programmable gate array (FPGA), a microprocessor, a multi-core processor, and combinations thereof. The one or more processor 108 is capable of communicating with the one or more memories 110 via a path 116 which can be implemented as a data bus, for example. The one or more processor 108 is capable of communicating with the input device 112 and the output device 114 via paths 120a and 120b, respectively. Paths 120a and 120b may be implemented similarly to, or differently from, path 116. The one or more processor 108 is further capable of interfacing and/or communicating with the one or more user terminals 104 via the network 106, such as by exchanging electronic, digital and/or optical signals via one or more physical or virtual ports using a network protocol such as TCP/IP, for example. It is to be understood that in certain embodiments using more than one processor 108, the one or more processor(s) 108 may be located remotely from one another, located in the same location, or comprising a unitary multi-core processor (not shown). The one or more processor 108 is capable of reading and/or executing processor executable code and/or or creating, manipulating, altering, and storing computer data structures into the one or more memory 110.

The one or more memory 110 stores processor executable code and may be implemented as any conventional non-transitory memory 110, such as random access memory (RAM), a CD-ROM, a hard drive, a solid state drive, a flash drive, a memory card, a DVD-ROM, a floppy disk, an optical drive, and combinations thereof, for example. It is to be understood that while one or more memory 110 is shown located in the same physical location as the host system 102, the one or more memory 110 may be located remotely from the host system 102 and may communicate with the one or more processor 108 via the network 106. Additionally, when more than one memory 110 is used, one or more memory 110a may be located in the same physical location as the host system 102, and one or more memory 110b may be located in a remote physical location from the host system 102. The physical location(s) of the one or more memory 110 can be varied, and the one or more memory 110 may be implemented as a “cloud memory” i.e., one or more memory 110 which is partially, or completely based on or accessed using the network 106.

The input device 112 transmits data to the processor 108, and can be implemented as a keyboard, a mouse, a touch-screen, a camera, a cellular phone, a tablet, a smart phone, a PDA, a microphone, a network adapter, and combinations thereof, for example. The input device 112 may be located in the same physical location as the host system 102, or may be remotely located and/or partially or completely network-based. The input device 112 communicates with the processor 108 via path 118.

The output device 114 transmits information from the processor 108 to a user, such that the information can be perceived by the user. For example, the output device 114 can be implemented as a server, a computer monitor, a cell phone, a tablet, a speaker, a website, a PDA, a fax, a printer, a projector, a laptop monitor, and combinations thereof. The output device 114 can be physically co-located with the host system 102, or can be located remotely from the host system 102, and may be partially or completely network based (e.g., a website). The output device 114 communicates with the processor 108 via the path 120. As used herein the term “user” is not limited to a human, and may comprise a human, a computer, a host system, a smart phone, a tablet, and combinations thereof, for example.

The network 106 preferably permits bi-directional communication of information and/or data between the host system 102 and the user terminals 104. The network 106 may interface with the host system 102 and the user terminals 104 in a variety of ways, such as by optical and/or electronic interfaces, and may use a plurality of network topographies and protocols, such as Ethernet, TC/IP, circuit switched paths, and combinations thereof, for example. For example, the network 106 can be implemented as the World Wide Web (or Internet), a local area network (LAN), a wide area network (WAN), a metropolitan network, a wireless network, a cellular network, a GSM-network, a CDMA network, a 3G network, a 4G network, a satellite network, a radio network, an optical network, a cable network, a public switched telephone network, an Ethernet network, and combinations thereof, and may use a variety of network protocols to permit bi-directional interface and communication of data and/or information between the host system 102 and the one or more user terminals 104.

The one or more user terminals 104 can be implemented as a personal computer, a smart phone, network-capable TV set, TV set-top box, a tablet, an e-book reader, a laptop computer, a desktop computer, a network-capable handheld device, a video game console, a server, a digital video recorder, a DVD-player, a Blu-Ray player, and combinations thereof, for example. In an exemplary embodiment, the user terminal 104 comprises an input device 122, an output device 124, a processor (not shown) capable of interfacing with the network 106, processor executable code (not shown), and a web browser capable of accessing a website and/or communicating information and/or data over a network, such as the network 106. As will be understood by persons of ordinary skill in the art, the one or more user terminals 104 may comprise one or more non-transient memories comprising processor executable code and/or software applications, for example.

The input device 122 is capable of receiving information input from a user and/or another processor, and transmitting such information to the user terminal 104 and/or to the host system 102. The input device 122 may be implemented as a keyboard, a touch-screen, a mouse, a trackball, a microphone, a fingerprint reader, an infrared port, a slide-out keyboard, a flip-out keyboard, a cell phone, a PDA, a video game controller, a remote control, a fax machine, a network interface, and combinations thereof, for example.

The output device 124 outputs information in a form perceivable by a user and/or readable or executable by another processor. For example, the output device 124 can be a server, a computer monitor, a screen, a touch-screen, a speaker, a website, a TV set, a smart phone, a PDA, a cell phone, a fax machine, a printer, a laptop computer, and combinations thereof. It is to be understood that in some exemplary embodiments, the input device 122 and the output device 124 may be implemented as a single device, such as, for example, a touch-screen or a tablet. It is to be further understood that as used herein the term user is not limited to a human being, and may comprise a computer, a server, a website, a processor, a network interface, a human, a user terminal, a virtual computer, and combinations thereof, for example.

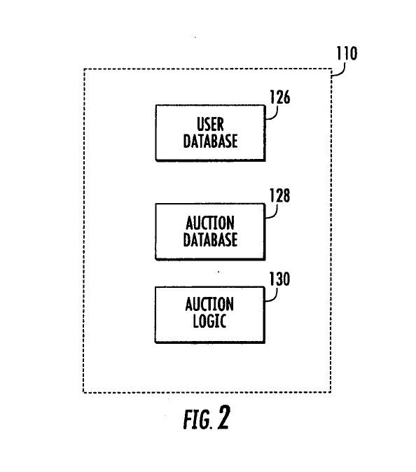

Referring now to FIG. 2, the one or more memory 110 preferably stores processor executable code and/or information comprising a user database 126, an auction database 128, and an auction logic 130. The processor executable code may be written in any suitable programming language, such as C++. The user database 126 and the auction database 128 can be stored as a data structure, such as a relational database and/or one or more data table(s), for example.

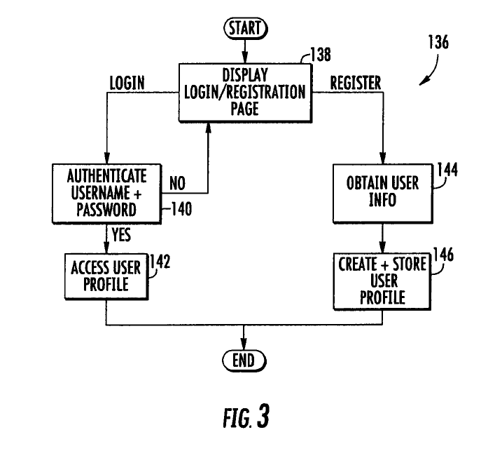

The user database 126 preferably comprises user profile information about users registered with the host system 102. In an exemplary embodiment shown in FIG. 3, one or more users accessing an auction website of the host system 102 via user terminal 104 can be directed by the processor 108 to a login/registration portion of the website in a step 138. If the user has previously registered with the host system 102, the user may be prompted by the processor 108 to provide login credentials (e.g., username and password), which allow the processor 108 to authenticate the user against the user database 126 in a step 140. Each user of the host system 102 preferably has a user profile including information stored in the user database 126. The host system 102 accesses the user profile in a step 142. The user profile may include the following information: demographic information including name, age, address, billing account information, username, password, behavioral information, experience, gender, and the like, for example. If the user authentication is successful, the user's profile may be accessed by the processor 108. If the user authentication fails, the user may be returned to the login/registration page, where the user may be prompted for a username and password again. Optionally, the processor 108 may block a user from entering a username and password after a preset number of failed authentication attempts. It is to be understood that the user database 126 may further comprise user profiles for users who have not registered with the host system 102, but who have previously visited or are currently accessing an auction website maintained by the host system 102, for example.

If the user is not registered with the host system 102, demographic information, billing account information, shipping address, desired username and password, and other information may be collected from the user and/or generated by the host system 102 in a step 144. Further in step 144, the user may be allowed to purchase one or more bids and/or bid packs and such purchased bids and/or bid packs may be credited to the user's account. It is to be understood that bids for which the user pays monetary consideration may be hereinafter referred to as “real bids.” Other types of bids may not cost the user any money and may be referred to as “free bids,” voucher bids,” and “bonus bids,” for example. Such free bids, voucher bids, and/or bonus bids may be used or placed in one or more auctions 134, and may be treated as real bids for the purposes of an auction 134 by the host system 102, for example.

A user profile is created and preferably stored in the user database 126 by the processor 108 in a step 146. The user profile may be stored in the user database 126 and may be provided, or made available to a user in the form of a user account/registration page (not shown), as will be understood by persons of ordinary skill in the art presented with the instant disclosure, for example.

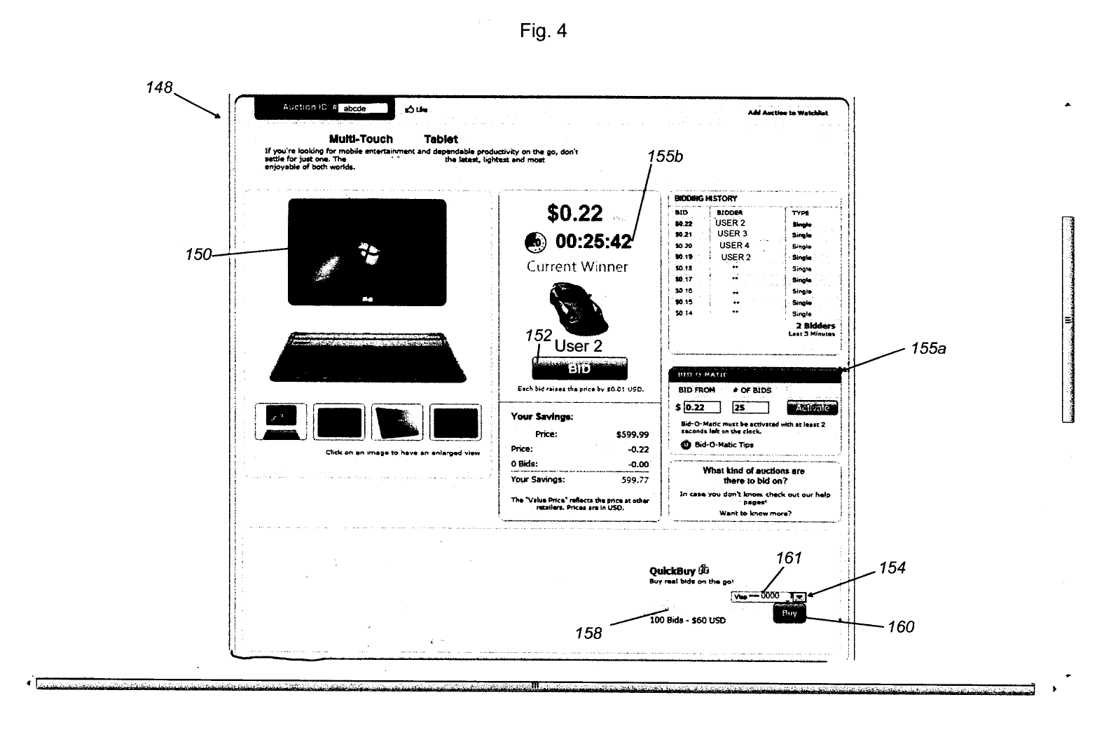

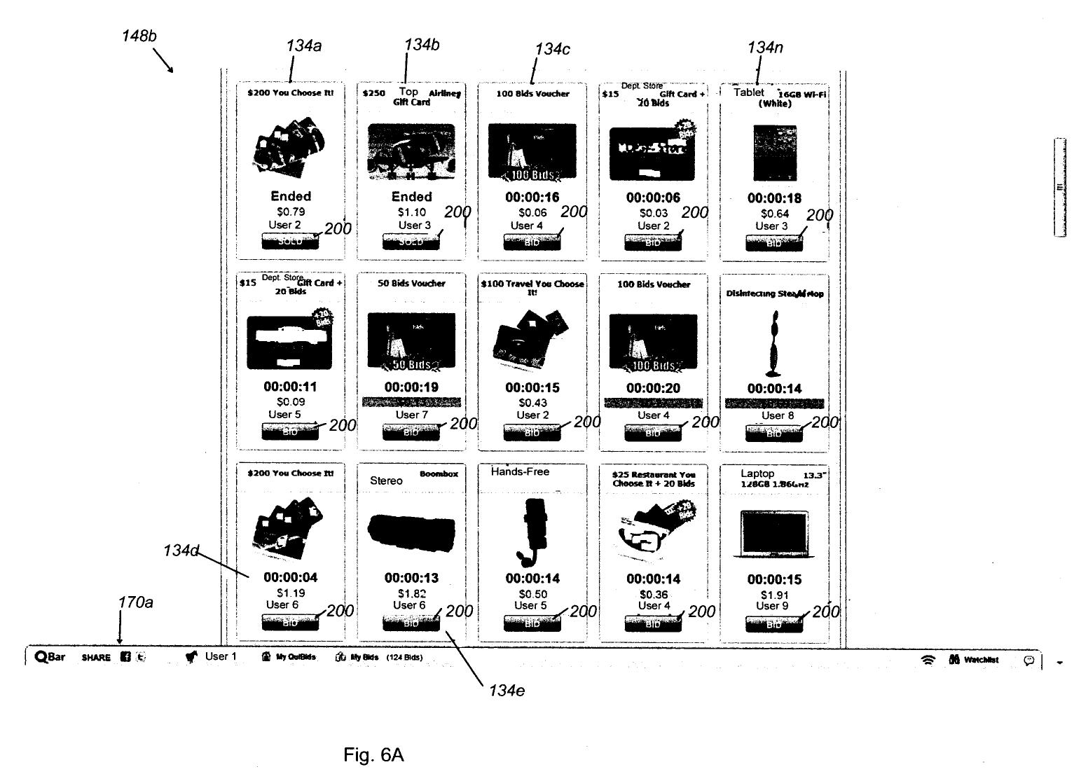

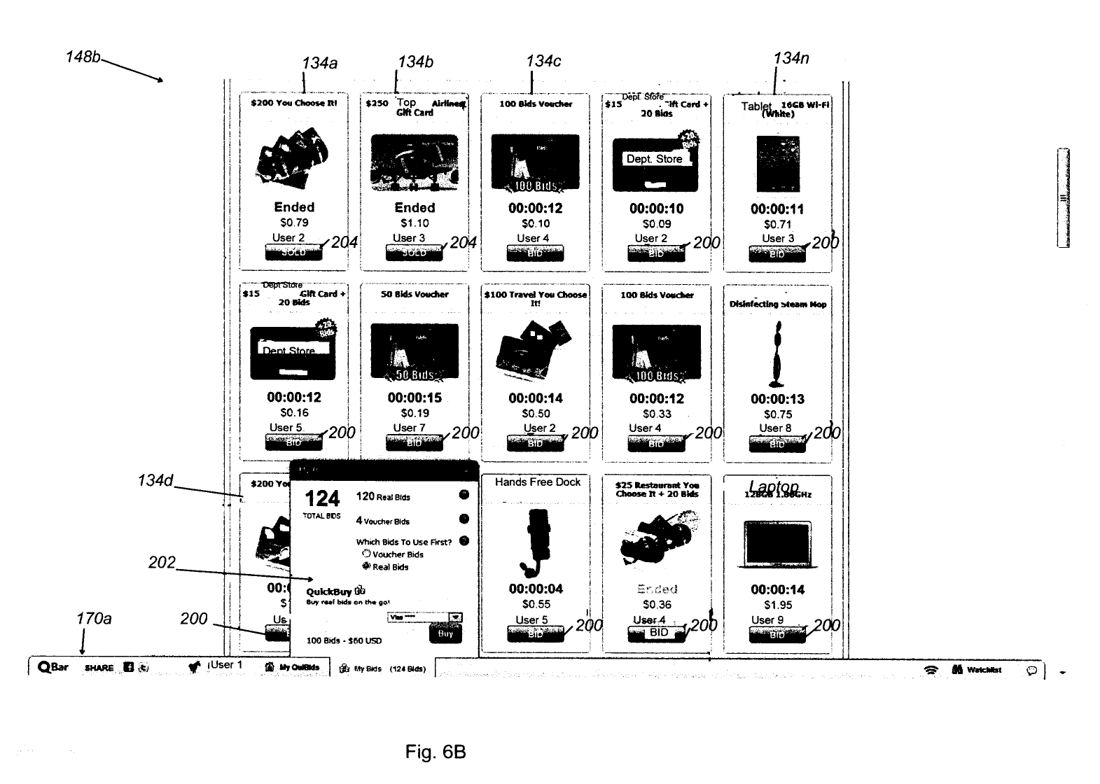

Referring now to FIG. 4, an exemplary embodiment of the auction database 128 preferably comprises one or more auctions 134, one or more of which auctions 134 may be provided to a user via the transmission of signals over the network 106 as an auction page 148. The signals are preferably computer executable code that can be rendered into one or more auction pages 148, for example by software/hardware of the user terminals 104. For example, the signals can be in the form of hypertext mark-up language (HTML) that can be used to create documents on the World Wide Web. HTML defines the structure and layout of a web document by using a variety of tags and attributes. The user terminals 104 may include a software program referred to as a web browser for reading the HTML documents and composing such HTML documents into visible or audible web pages which are provided to the user in a user-perceivable format. The auction page 148 displays a single auction 134, but it is to be understood that an auction page 148 according to the instant inventive concept(s) may display two or more auctions 134 simultaneously as will be described with reference to FIGS. 6A-6B below, for example.

The auction 134 displayed on the auction page 148 desirably comprise start time, end time, auctioned item, list price, auction price, cost to bid, and time remaining until the auction 134 ends. The auction page 148 may comprise one or more mechanisms such as a bid mechanism 152 allowing a user to place a bid on the item, and a quick-buy mechanism 154 allowing the user to buy one or more bids desirably without leaving the auction page 148.

The auction 134 may be scheduled to begin at a certain time (start time), run (or be open) for a certain amount of time, and end at a certain time (end time), for example. An auction timer displayed on the auction page 148 may be started by the processor 108 at the start time of the auction 134, and may countdown time to the end time of the auction 134, for example. Such auction timer may be reset one or more times during the auction 134, and in some embodiments the end time may be dynamically pushed back in response to bids received in the auction 134, for example.

The memory 110 further stores processor executable code and/or instructions, which may comprise auction logic 130 (FIG. 2): The auction logic 130 comprises processor executable instructions and/or code, which when executed by the processor 108, cause the processor 108 to generate, maintain, provide, and/or host a website providing one or more online auctions 134, for example. The auction logic 130 further causes the processor 108 to provide the one or more online auctions 134 to one or more users by transmitting signals to one or more user terminals 104 over the network 106, and to allow the one or more users to participate in the one or more online auctions 134 as will be described herein below, for example.

Providing an online auction 134 may comprise scheduling an auction 134, storing the scheduled auction into auction database 128, and providing the auction 134 by transmitting a signal over the network 106 to one or more of the user terminals 104, causing the user terminal 104 to display an auction page 148, starting the auction timer at the scheduled time, and allowing one or more users to bid in the auction 134 and/or purchase bids to use in the auction 134, for example.

The auction page 134 has an auction item 150, a bid mechanism 152, and a quick-buy mechanism 154.

The auction item 150 may be any item 150 being auctioned, and is not limited to a physical item, but may comprise a virtual item, a service, a subscription, a coupon code, a redeemably certificate, a cash prize, a bid pack, one or more bids, a gift card, and combinations thereof, for example. A price, such as a retail price of the auction item 150 may be listed on the auction page 148. Further, the auction page 148 has an auction end time, a current auction price (and currency such as $, £, or [symbol] , for example), and lists the currently winning user along with the recent bidding history of the auction 134. The auction page 148 may further have an automatic bidding mechanism 155a, allowing one or more bidders to set up a number of bids to be automatically placed on their behalf in the auction 134.

The bid mechanism 152 allows a user to place a bid in the auction 134, such as, for example, by activating the bid mechanism 152 by a mouse click, a key press, a screen touch, and combinations thereof. The bid mechanism 152 may be implemented in any conventional manner, such as a clickable button, a user-selectable interface, a HTML link, a Flash element, and combinations thereof, for example.

In operation, the bid mechanism 152 is provided as a part of the auction page 148 to the user terminal 104 communicating with the host system 102 via the network 106, as described above. In response to receiving a signal over the network 106 from the user terminal 104 indicating the bid mechanism 152 has been activated, the host system 102 raises the auction price by a predetermined incremental amount (e.g., $0.01), and may optionally reset a timer 155b for the auction end time by a preset amount (e.g. extend the end time by 15 seconds). The user may also be listed on the auction page 148 as the currently winning user of the auction 134, for example.

The quick-buy mechanism 154 comprises a billing account selector 156, a bid pack selector 158, and a buy bid button 160. The quick-buy mechanism 154 desirably includes a graphical element 161 that is within the contents of the auction page 148 but which does not interfere with the bid mechanism 152 such that the quick-buy mechanism 154 can be activated without leaving the auction page 148.

It is to be understood that while the quick-buy mechanism 154 is shown as being positioned in the lower right-hand corner of the auction page 148, such position is merely exemplary, and a quick-buy mechanism 154 according to the instant inventive concept(s) may be positioned anywhere on an auction page 148. In some exemplary embodiments, the quick-buy mechanism 154 may be implemented as a pop-up window, and a floating bar, a task-bar pop-up, a browser toolbar, a smart-phone application, a hardware device, and combinations thereof.

Further, it is to be understood that in some exemplary embodiments the quick-buy mechanism 154 may be omitted from the auction page 148, and may only be provided on the auction page 148 in response to a user placing at least one, at least two, or a predetermined number of bids in the auction 134. In other exemplary embodiments, the quick-buy mechanism 154 may only be provided a certain preset amount of time before an auction 134 is scheduled to end, or may only be provided to registered users who have saved a credit card account in their user profile as described above.

The billing account selector 156 is shown as a data entry field, which may include a conventional drop-down box, but may be implemented in variety of ways. The billing account selector 156 desirably defaults to the last billing account used by the user, or to a billing account saved in the user's profile, if only one billing account was provided by the user during the user's registration with the host system 102 as described above. If more than one billing account is saved in the user profile, the user may expand the drop-down box and specify which billing account they wish to use to purchase bids. Further, in some embodiments, the user may be allowed to input a billing account (e.g., credit card number, debit card number, checking account number) into the billing account selector 156, for example. In some exemplary embodiments of the instant inventive concept, the billing account selector 156 may be omitted, and the host system may use one or more billing accounts stored in a user's profile to complete the sale of bids or bid packs to the user.

The bid pack selector 158 is shown as a slidable bar, which may be slid by holding down a button of a mouse having its cursor or pointer placed over the bar, for example, to select the desired amount of bids (or size of the bid pack) the user wishes to purchase. Such amounts of bids or size of bid pack may vary from one to infinity, and a price may be displayed and changed, as the amount of bids is changed by sliding the bar, for example. It is to be understood that the price displayed may reflect a discount for the purchase of a certain preset amount of bids or a certain size of bid pack, for example. Further, in some exemplary embodiments, the slidable bar may be omitted, and the user may only have the ability to purchase one or more pre-set amount of bids, such as a bid pack of 25 bids, a bid pack of 50 bids, or a bid pack of 75 bids, for example. In other exemplary embodiments the bid pack selector 158 may be implemented as a drop-down menu or drop-down box, one or more checkboxes, or as a data entry field allowing the user to manually enter the number of bids they wish to purchase, and combinations thereof. In some exemplary embodiments, the bid pack selector 158 may be omitted, and the user may be allowed to purchase only a single preset number of bids by activating the quick-buy mechanism 154.

The buy bid button 160 may be implemented as any mechanism capable of being activated by a user, such as a clickable button, link, or icon, or a selectable graphic element, for example. The buy bid button 160 functions to finalize the purchase of the selected number of bids (e.g., via the bid pack selector 158), by charging the billing account selected (e.g., via the billing account selector 156) for the corresponding amount as described above, for example. The purchased bids (or bid pack) may then be credited to the user's account.

As will be understood by a person of ordinary skill in the art, the functionality of the quick-buy mechanism 154 described above is desirably provided to a user without disrupting, affecting, or impairing the visibility and functionality of the bid mechanism 152. For example, a user may activate the bid mechanism 152 and the quick-buy mechanism 154 simultaneously, concurrently, or in any order. The bid mechanism 152 and the quick-buy mechanism 154 desirably operate independently of one another, and activation of one may not interfere with, impair, or affect the activation, visibility, and functionality of the other, in any way. The quick-buy mechanism 154 is implemented on the auction page 148 such that at all times during the activation of the quick-buy mechanism 154 by a user, or the interaction of the user with the quick-buy mechanism 154, the bid mechanism 152 remains at least partially visible to the user and fully functional. In some embodiments, the quick-buy mechanism 154 is implemented on an auction page 148 such that at all times during the activation of the quick-buy mechanism 154 by a user, or the interaction of the user with the quick-buy mechanism 154, the bid mechanism 152 remains visible to the user and fully functional, while the auction page 148 remains at least partially visible to the user. This allows the user to quickly and conveniently purchase bids, while being allowed to observe the progress of the auction 134 via the auction page 148 and/or bid in the auction 134 by activating the bid mechanism 152 at any time before, during, or after the user has activated or interacted with the quick-buy mechanism 154, and regardless of whether the user has activated the quick-buy mechanism 154.

It is to be understood that a user may activate the quick-buy mechanism 154 regardless of whether the user has activated the bid mechanism 152, for example. It is to be further understood that a user may activate the quick-buy mechanism 154 regardless of the number of remaining bids in the user's account, for example. In some exemplary embodiments, the quick-buy mechanism 154 may be provided to a user in response to a certain preset number of bids (e.g. real bids, voucher bids, and/or free bids) remaining in the user's account, such as 10, 15, 5, 1, 20, or 25 bids remaining in the user's account.

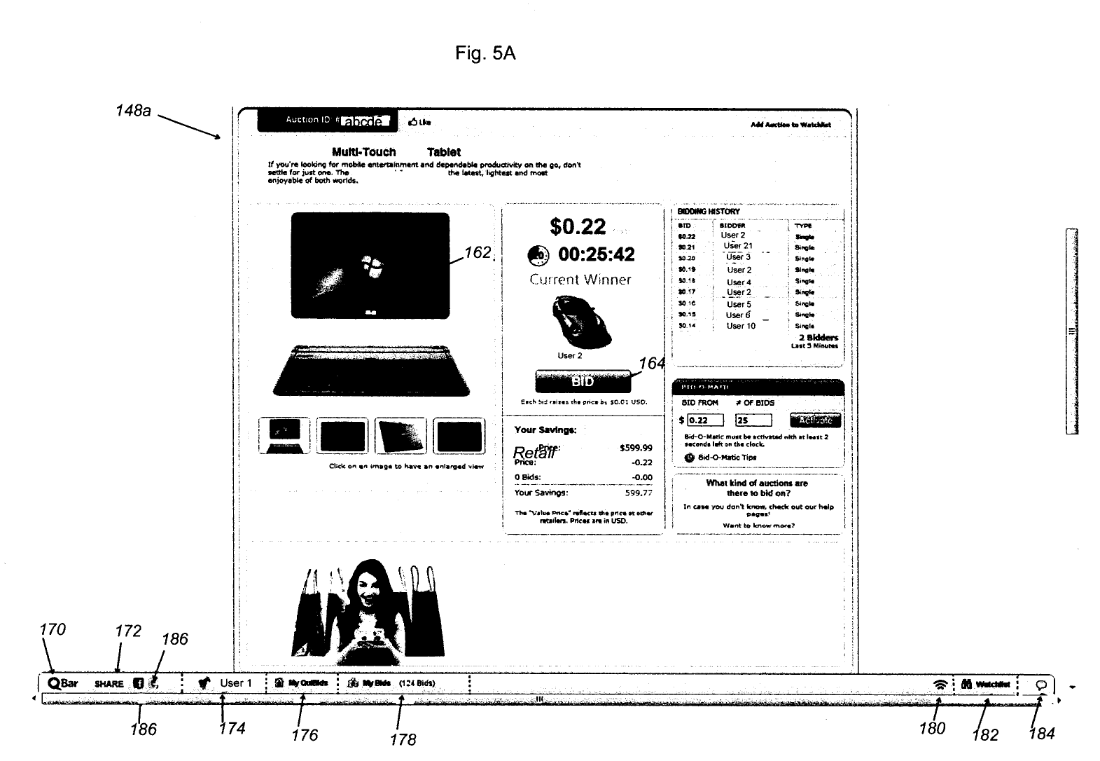

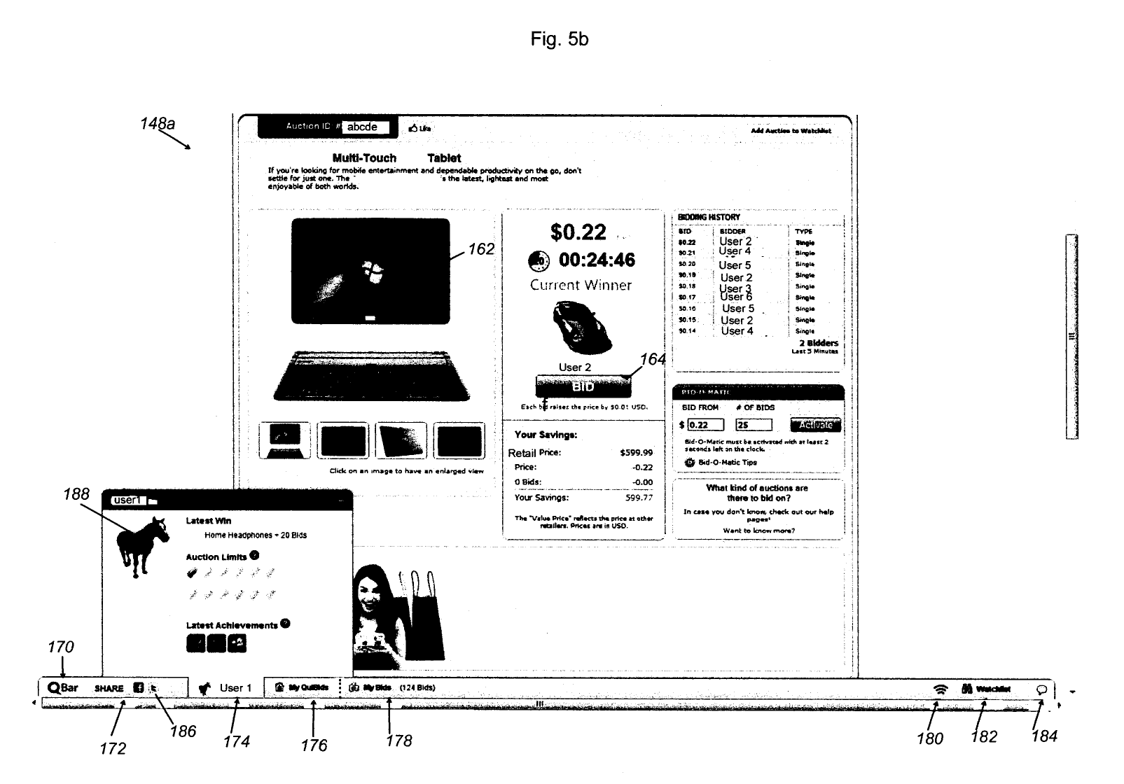

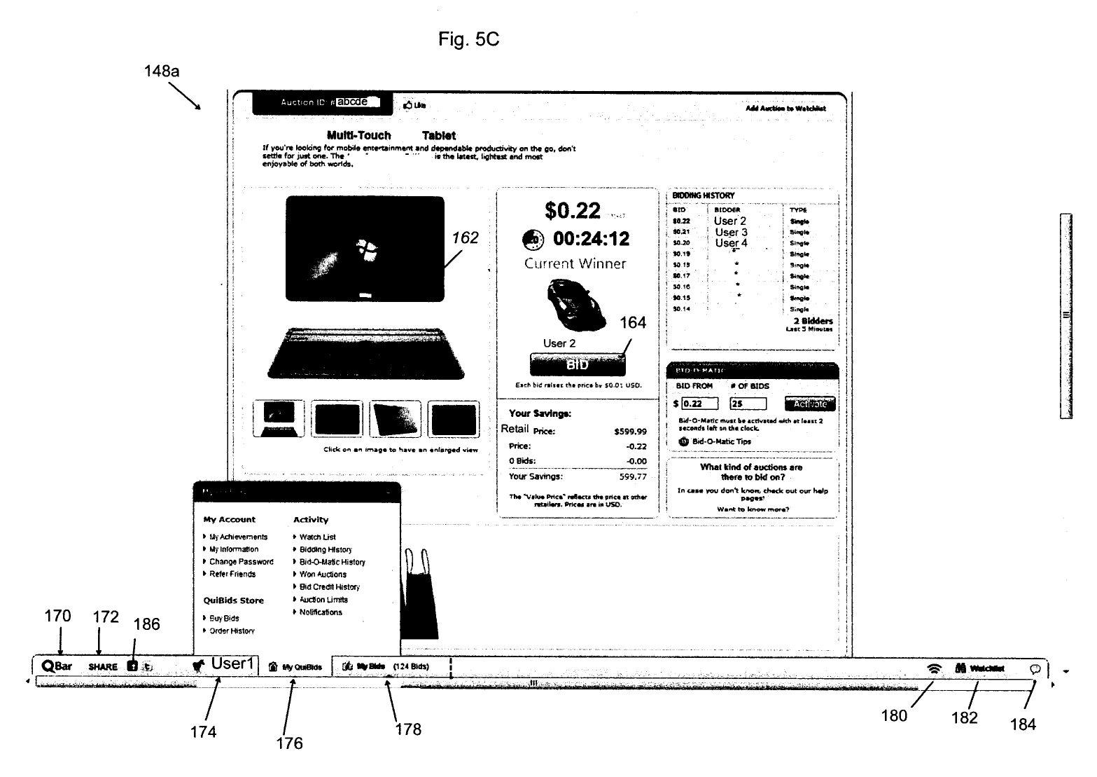

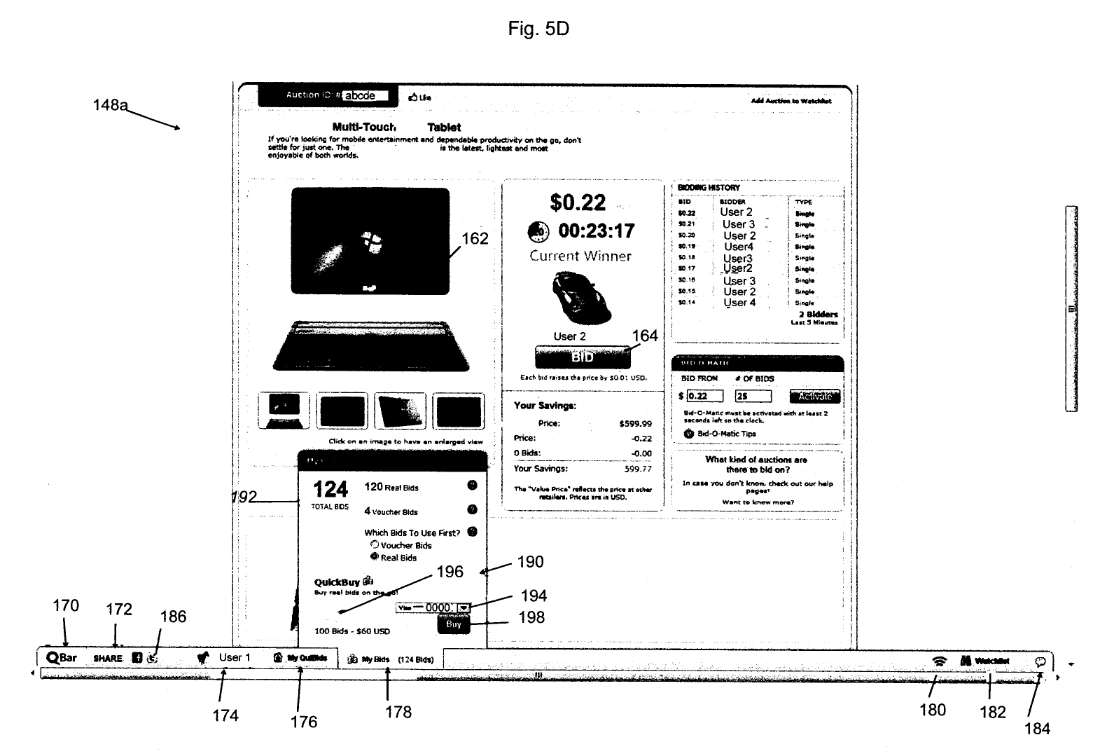

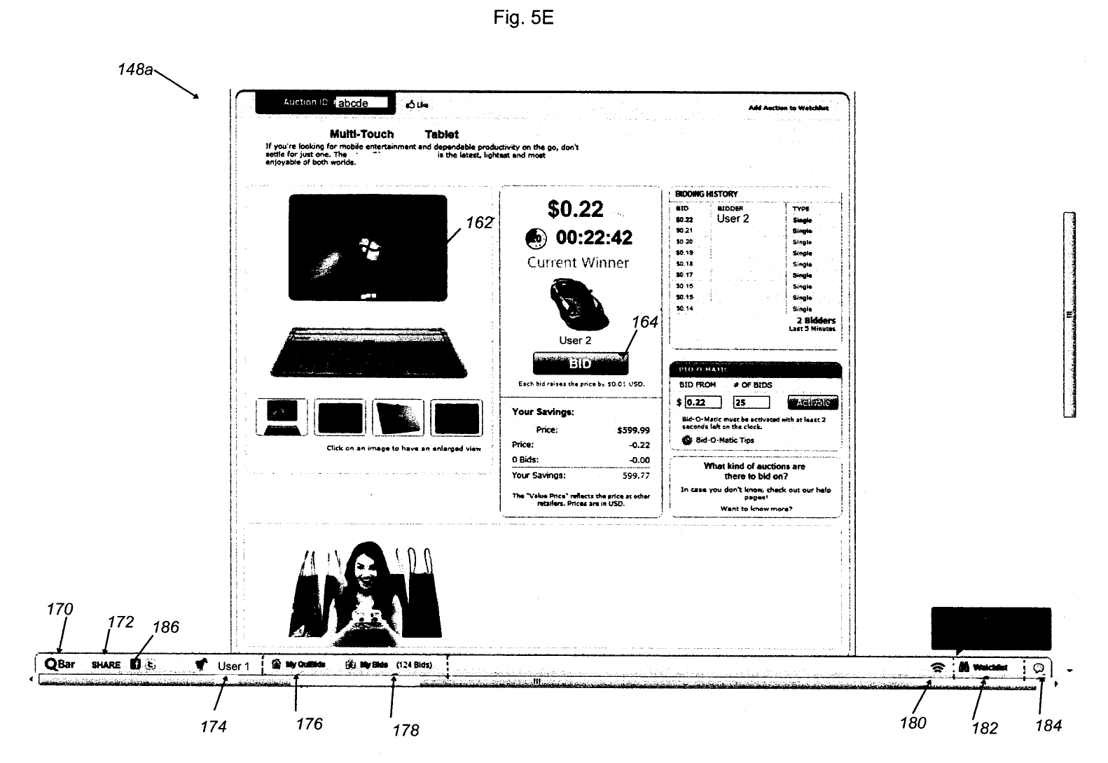

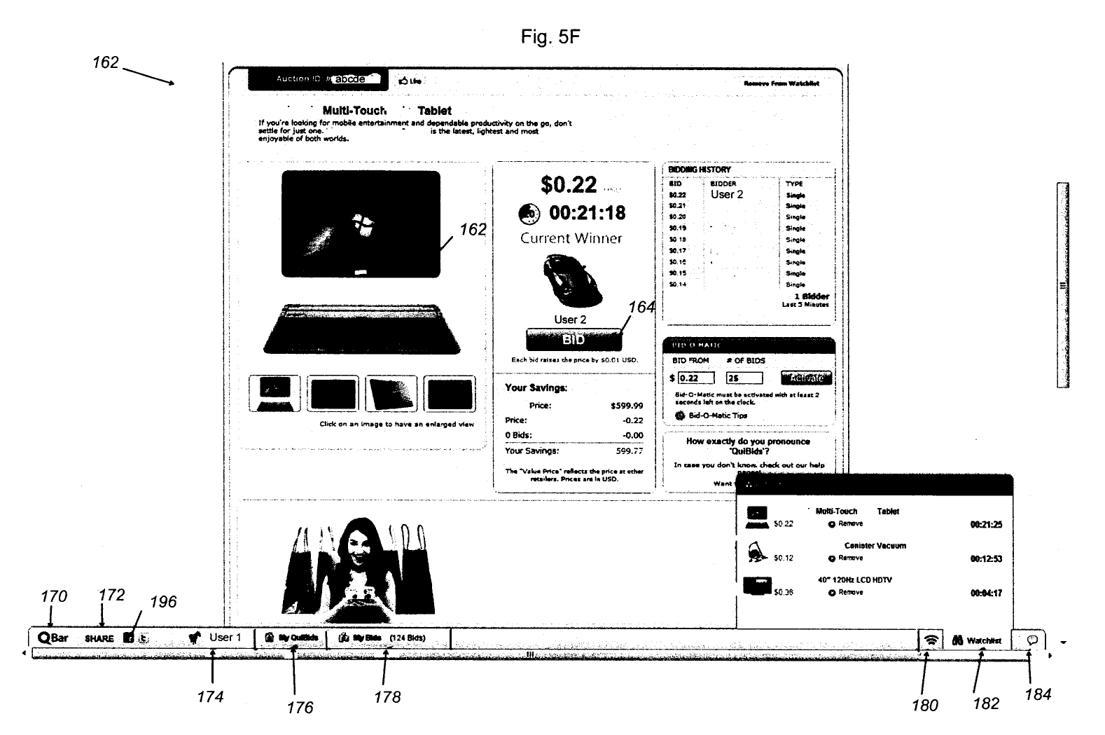

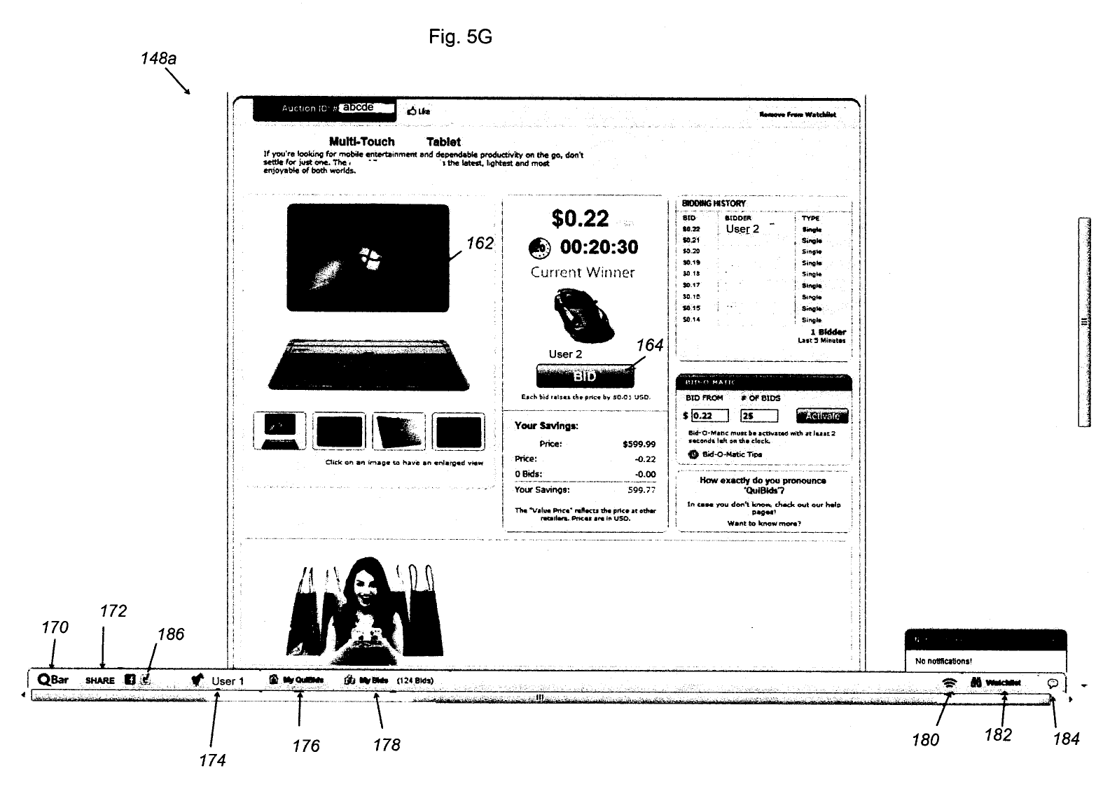

In an exemplary embodiment shown in FIGS. 5A-5G, an auction page 148a according to the instant disclosure comprises an auction item 162, a bid mechanism 164, and an information bar 170 having a quick-buy portion 178.

The auction page 148a may be implemented similarly to auction page 148, or may be implemented differently from auction page 148, for example.

The information bar 170 is shown in FIGS. 5A-5G as a horizontal bar positioned towards the bottom of the auction page 148a. It is to be understood however that an information bar 170 according to the instant inventive concept(s) may be implemented as any shape object placed anywhere on the auction page 148a, such as for example a square element, a side bar, a vertical bar, a circular object, and combinations thereof. Further, in some exemplary embodiments, the information bar 170 may be implemented as a browser toolbar, which may be displayed in the status bar, sidebar, bookmarks bar, address bar, or in a custom toolbar portion of the browser window, and combinations thereof, for example.

The information bar 170 comprises a social media portion 172, a profile portion 174, an account portion 176, a quick-buy portion 178, a connection meter portion 180, a watchlist portion 182, and a notifications portion 184.

Further, the information bar 170 may be selectively toggled on and off in some exemplary embodiments, and the host system 102 may remember the last setting of a user and present the information bar toggled on or off accordingly, such as by setting a browser cookie on the user's browser and reading the cookie on a subsequent visit of the auction website by the user, for example. As used herein, “toggled off” means that the information bar 170 is in a minimized state, but it is to be understood that a portion of the information bar 170 is desirably still visible on the auction page 148a and allows a user to deploy the information bar 170 to an expanded state by interacting with the information bar 170. Conversely, “toggled on” means that the information bar 170 is deployed in its expanded state, but it is to be understood that a user may toggle off the information bar 170 as described above. In an exemplary embodiment, the information bar 170 may be selectively minimized and deployed (or toggled off and toggled on), such that the various portions of the information bar 170 are not visible when the information bar 170 is minimized (or toggled off), and are visible when the information bar 170 is deployed (or toggled on).

FIG. 5A shows the information bar 170 in a deployed state, but with all of its portions being in their respective non-expanded positions. In order to expand one or more of the portions of the information bar 170, a user may click on the respective portion with their mouse pointer or cursor, hover the mouse cursor over the respective portion for a predetermined amount of time, touch the respective portion on a touch-screen, or use a keyboard shortcut to expand a portion of the information bar 170, and combinations thereof for example. Further, the host system 102 may transmit a signal over the network 106 to a browser on the user terminal 104 causing one or more of the portion of the information bar 170 to expand and display certain information in a form perceivable by a user, as will be described below with respect to the individual portions of the information bar 170 for example.

The social media portion 172 comprises user-selectable social-media sharing mechanisms 186, allowing the user to share their participation in an auction, an auction page, an item won, or other information with a social media site, such as Facebook, Twitter, Google+, or Foursquare, for example. It is to be understood that user-selectable social-media sharing mechanisms 186 may be implemented as a simple link to a social media site, as pop-up applets, or in any other suitable manner, as will be understood by persons of ordinary skill in the art. Further, in some exemplary embodiments, when something is shared in a social media site with the user, one or more of the social-media sharing mechanisms 186 may notify the user of such event such as by automatically expanding, changing a color, emitting an audible alert, or causing the information bar 170 to display a notification in the notification portion 184 as will be described below.

In some exemplary embodiments, the social media portion 172 may allow a user to interact with another user currently logged in the host system 102, such as by inviting them to join the user in the auction 134, bragging about recent wins, sending certain gift items, free bids, badges, or other virtual items to other users, sharing photos, sharing auction watch lists, exchanging instant messages, emoticons, or pinging or tagging other users, as will be appreciated by persons or ordinary skill in the art presented with the instant disclosure. It is to be understood that the social media portion 172 is optional and may be omitted in some exemplary embodiments of an information bar 170 according to the instant inventive concept(s).

Referring now to FIG. 5B, shown therein is the auction page 148a with the profile portion 174 of the information bar 170 shown expanded. The profile portion 174 is shown as comprising an avatar 188, which may be chosen by the user, or may be assigned to the user by the host system 102, for example. While the avatar 188 is displayed as a horse in FIG. 5B, an avatar 188 may be a photograph of the user, an animation such as a GIF animation, or a depiction of an object, real, virtual, or imaginary, one or more digits or characters, and combinations thereof, for example. Further, in some embodiments, a user may select which avatar 188 is to be displayed among two or more avatars 188 associated with the user, for example. In other exemplary embodiments, the avatar 188 may be omitted, and the user may be identified by a user name, or a user number, for example.

The profile portion 174 may further comprise a user's achievements, such as badges, medals, or awards won, any auction win limits imposed on the user to limit the number of auctions a user may win in a period of time, and the last auction won by the user, if any, for example. It is to be understood that the profile portion 174 is optional and may be omitted in some exemplary embodiments of the information bar 170 according to the instant inventive concept(s).

Referring now to FIG. 5C, shown therein is the auction page 148a with the account portion 176 of the information bar 170 shown expanded. The account portion 176 is shown as comprising one or more links to various portions of the user's account on the host system 102, including but not limited to a user's information and password, a user's bidding history, a bid purchase mechanism, and other similar links. Clicking on one or more of the links in the account portion 176 may open a further expanded portion (not shown) of the information bar 170, may cause a different browser window to pop up, or open, or may launch a new webpage in a separate browser window/tab, and combinations thereof, for example. It is to be understood that while the account portion 176 is shown as comprising links, the account portion 176 may comprise any mechanism that may be activated by a user, such as a hyperlink, a clickable button, an icon, and combinations thereof, for example. It is to be further understood that the account portion 176 is optional and may be omitted in some exemplary embodiments of the instant inventive concept(s).

Referring now for FIG. 5D, shown therein is an auction page 148a with the quick-buy portion 178 of the information bar 170 shown expanded. The quick-buy portion 178 comprises a quick-buy mechanism 190, and an optional bid type selection mechanism 192.

The quick-buy mechanism 190 may be implemented similarly to the quick-buy mechanism 154, or differently therefrom. The quick-buy mechanism 190 shown in FIG. 5D comprises a billing account selector 194, a bid pack selector 196, and a buy bid button 198.

It is to be understood that while the quick-buy mechanism 190 is shown as being positioned towards the middle of the information bar 170 and towards the bottom of the auction page 148a, such position is merely exemplary, and the quick-buy mechanism 190 according to the instant inventive concept(s) may be positioned anywhere on the auction page 148a, provided that the positioning of the quick-buy mechanism 190 does not interfere with, impair, or affect the visibility and functionality of the bid mechanism 164. However, in some exemplary embodiments, the quick-buy mechanism 190 may be positioned such that it may partially obstruct or interfere with the visibility of the bid mechanism 164, provided that the functionality of the bid mechanism 164 is not impaired or disrupted by such positioning of the quick-buy mechanism 190. Further, in some exemplary embodiments, the quick-buy mechanism 190 may be implemented as a pop-up window, and a floating bar, an anchored bar, a task-bar pop-up, a browser toolbar, a smart-phone application, a bookmark, a hardware device, and combinations thereof.

In some exemplary embodiments, the quick-buy mechanism 190 may only be provided to users having a certain preset number of bids remaining in their account, while in other exemplary embodiments the quick-buy mechanism 190 may be provided to users regardless of the number of bids remaining in the user's account. Further, a user may be required to save at least one billing account (e.g. credit card number, debit card number, checking account number, etc.) in the user's profile prior to being provided with the quick-buy mechanism 190, for example. Further, it is to be understood that in some exemplary embodiments the quick-buy mechanism 190 may be omitted from the auction page quick-buy portion 178, and may only be provided on the quick-buy portion 178 in response to a user placing at least one, at least two, or a predetermined number of bids in the auction 134. In other exemplary embodiments, the quick-buy mechanism 190 may only be provided a certain preset amount of time before an auction 134 is scheduled to end, or may only be provided to registered users who have saved a credit card account in their user profile as described above, as will become apparent to persons of ordinary skill in the art presented with the instant disclosure.

The billing account selector 194 is shown as s conventional drop-down box, but may be implemented in a variety of ways. The billing account selector 194 desirably defaults to the last billing account used by the user, or to the saved billing account, if only one billing account is provided by the user. If more than one billing account is saved in the user profile, the user may expand the drop-down box and specify which billing account they wish to use to purchase bids or bid packs. Further, in some embodiments, the user may be allowed to input a billing account (e.g., credit card number, debit card number, checking account number) into the billing account selector 194 as part of activating the quick-buy mechanism 190, for example. It is to be understood that the billing account selector 194 is optional and may be omitted in some exemplary embodiments of the information bar 170 according to the instant inventive concept(s).

The bid pack selector 196 is shown as a slidable bar, which may be slid by holding down a primary button of a mouse cursor placed over the bar, for example, to select the desired amount of bids or the size of the bid pack the user wishes to purchase. Such amount of bids or size of bid pack may vary from one to infinity, and a price may be displayed and changed, as the amount of bids is changed by sliding the bar, for example. It is to be understood that the price displayed may reflect a discount for the purchase of a certain preset amount of bids or a certain size of bid pack, for example. Further, in some exemplary embodiments, the slidable bar may be omitted, and the user may only have the ability to purchase one or more pre-set amount of bids, such as a bid pack of 25 bids, a bid pack of 50 bids, or a bid pack of 75 bids, for example. In some exemplary embodiments, an input box may allow the user to enter the desired amount of bids or size of bid packs they wish to purchase. It is to be understood that the bid pack selector 196 is optional and may be omitted in some exemplary embodiments of the information bar 170 according to the instant inventive concept(s).

The buy bid button 198 may be implemented as any interface mechanism capable of being activated by a user, such as a clickable button, link, or icon, or a selectable graphic interface element, for example. The buy bid button 198 functions to complete the activation of the quick-buy mechanism 190 by finalizing the purchase of the selected number of bids via the bid pack selector 196, such as by charging the billing account selected via the billing account selector 194 for the corresponding amount, as described above. The purchased bids may be credited to the user's account.

As will be understood by a person of ordinary skill in the art, the functionality of the quick-buy mechanism 190 described above is desirably provided to the user without disrupting, impairing, or affecting the visibility and functionality of the bid mechanism 164. For example, the user may activate the bid mechanism 164 and the quick-buy mechanism 190 simultaneously, concurrently, or in any order. The bid mechanism 164 and the quick-buy mechanism 190 operate independently of one another, and activation of one desirably does not interfere with, disrupt, impair, or affect the activation, visibility, and functionality of the other in any way. The quick-buy mechanism 190 is implemented on an auction page 148a such that at all times during the activation of the quick-buy mechanism 190 by the user, or the interaction of the user with the quick-buy mechanism 190, the bid mechanism 164 remains at least partially, but desirably completely visible to the user, and fully functional. In some embodiments, the quick-buy mechanism 190 is implemented on the auction page 148a such that at all times during the activation of the quick-buy mechanism 190 by the user, or the interaction of the user with the quick-buy mechanism 190, the bid mechanism 164 remains at least partially visible to the user and fully functional, and the auction page 148a remains at least partially, but desirably completely visible to the user. This allows the user to quickly and conveniently purchase bids, while being allowed to observe the progress of the auction 134 via the auction page 148a and/or bid in the auction 134 by interacting with the bid mechanism 164 at any time before, during, or after the user has activated or interacted with the quick-buy mechanism 190.

It is to be understood that the user may activate the quick-buy mechanism 190 regardless of whether the user has activated the bid mechanism 164, for example. It is to be further understood that the user may activate the quick-buy mechanism 190 regardless of the number of remaining bids in the user's account, for example.

In some exemplary embodiments of the instant inventive concept(s) the quick-buy mechanism 190 may be automatically expanded and provided to the user in response to the number of bids in the user's account dropping to a preset number, such as 20 bids, 10 bids, or 5 bids. Further, a notification may be provided to the user in the notification portion 184, to alert the user that a certain preset number of bids remain in their account as will be described below. Such preset number of bids may be set by the host system 102 or by the user, and may take into account any type of bids, such as real bids, voucher bids, and free bids, for example.

In some exemplary embodiments, the quick-buy portion 178 may be omitted from the information bar 170, and the quick-buy mechanism 190 may be implemented similarly to the quick-buy mechanism 154 as described above.

The bid type selection mechanism 192 comprises an indicator of the type of bids currently remaining in the user's account where more than one type of bids is available in the online auction system 100. For example, if there is more than one type of bids in the user's account, the indicator may list the remaining number of bids categorized by type, such as real bids, voucher bids, and free bids, for example. As will be understood by a person of ordinary skill in the art, real bids may be bids for which the user has paid monetary consideration, such as bids purchased with the quick-buy mechanism 190, or by a conventional bid purchasing mechanism, for example. Voucher bids may be bids that were won by the user in an auction 134, or as a part of a promotional event, for example. Likewise, free bids may be bids that are provided to certain users by the host system 102, or bids that are won in certain auctions 134, for example. It is to be understood that the above types of bids are exemplary only, and that many other types of bids may be implemented with certain embodiments of the instant inventive concept(s). Further, some exemplary embodiments of an online auction system 100 according to the instant inventive concept(s) may comprise only a single type of bids, such as real bids, and may omit the bid type selection mechanism 192.

The bid type selection mechanism 192 functions to allow the user to select which types of bids the user wishes to use first where one or more bids of at least two different types are available in the user's account. The user may choose which type of bid to place in the auction 134 by activating the bid mechanism 164. For example, a user may wish to minimize the use of real bids in order to save money, or to use any available real bids later on in the same auction 134, or in one or more different auctions 134, for example. The user would select the available free bids, or voucher bids, to be used up first, before using real bids, by activating the bid selection mechanism 192. The host system 102 receives a signal indicative of the user's selection of a type of bid, such as a real bid, and then desirably stores information indicative of the user's selection in the user's profile. The host system 102 may default to a certain type of bid, and may remember the user's selection of a type of bid for a subsequent visit, for example.

Referring now to FIG. 5E, shown therein is shown therein is the auction page 148a with the connection meter portion 180 of the information bar 170 shown expanded. The connection meter portion 180 is shown as a graphic representation of the connection strength and a text bubble (or pop-up window) indicating the respective strength of the connection. It is to be understood that the connection meter portion 180 may be implemented in any suitable way, such that a user is provided with information regarding the relative strength, speed, or stability of the network 106 connection between the user terminal 104 and the host system 102. In one exemplary embodiment, the connection strength and speed may be measured by the host system 102 by determining the time it takes from providing the auction page 148a to the user terminal 104 and the time it takes the user terminal 104 to respond. Exemplary time may be from 20 milliseconds to 60 milliseconds. Preset times may be correlated with a certain connection strength and speed and a corresponding indication may be displayed to the user via the connection meter portion 180 so that the user may understand the amount of time it takes for a signal indicative of the user activating the bid mechanism 164 or the quick-buy mechanism 190 to be transmitted to the host system 102. Further, if the connection strength and/or speed changes during an auction 134, the user may be provided with a visual and/or audible notification via the connection meter portion, for example. In an exemplary embodiment, such notification may also be provided by way of the notification portion 184 as will be described below. It is to be understood that the connection meter portion 180 is optional and may be omitted in some exemplary embodiments of an information bar 170 according to the instant inventive concept(s).

Referring now to FIG. 5F, shown therein is the auction page 148a with the watchlist portion 182 of the information bar 170 shown expanded. The watchlist portion 182 comprises a list of one or more auctions 134 selected by the user, which may be organized in a variety of ways, such as alphabetically, by auction end time, by item price, by an order that the user added the auctions 134 to the watchlist portion, or in any other suitable manner as will be appreciated by a person of ordinary skill in the art presented with the instant disclosure. The user may remove an auction from the watchlist portion 182 by activating an appropriate mechanism such as a remove button. Further, the host system 102 may automatically remove one or more auctions 134 that have ended from the watchlist portion 182, or may simply provide an indication that such auctions 134 have ended, or are about to end after a certain preset amount of time. For example, the watchlist portion may be used to alert a user that one or more of the auctions 134 in the watchlist portion 182 is about to end, for example, in 30 seconds, 60 seconds, 15 seconds, and any other time set by the host system 102 and/or specified by the user. A user may add an auction 134 to the watchlist portion 182 by activating a “watch this auction” mechanism (not shown) on the respective auction page 148 of the auction 134, for example. It is to be understood that the watchlist portion 182 may be optional and may be omitted in some exemplary embodiments of the information bar 170 according to the instant inventive concept(s).

Referring now to FIG. 5G, shown therein is an auction page 148a having the information bar 170 with the notification portion 184 expanded. The notifications portion 184 comprises a notification bubble which may pop up on mouse-over (e.g., hovering of the mouse pointer or cursor over an item for a preset amount of time), or when a new notification is displayed in the notification portion 184, for example. The notification portion 184 may be used by the host system 102 to provide notifications to the user, such as, but not limited to, notifications from any other portion of the information bar 170. The notification portion 184 may provide a notification and/or an alert in many conventional ways, such as visual elements provided on the auction page 148a, audible alerts played via a speaker of the user terminal 104, vibration alerts where available, and other similar methods as will be appreciated by persons of ordinary skill in the art. Additionally, the notification portion 184 may be configurable to send text messages, instant messages, e-mails, or other similar alerts to a user in response to preset trigger events, for example. It is to be understood that the notification portion 184 may be optional and may be omitted in some exemplary embodiments of the information bar 170 according to the instant inventive concept(s).

In one exemplary embodiment, the notification portion 184 may be configured to display an alert notifying a user that the number of bids remaining in their account has reached a preset or arbitrary low level. Such notification may be dismissed by the user, and may or may not be repeated when a second preset number of bids remain in the user's account.

Further, in some exemplary embodiments, the notification portion 184 may be used to display tutorial messages to users based on the user's behavior in an auction 134. If it appears that the user is not interacting with the auction page 148a in an expected manner, the user may be offered tutorials and other help and support materials via the notification portion 184.

In one exemplary embodiment, the notification portion 184 may be used to provide technical assistance and/or support to users, by allowing a user to chat with a customer service representative in real time, call a technical support of a help phone number, or e-mail technical support staff or customer agents, subject to customer service agent availability, and geographical location of the user, for example. A first help line number may be displayed to users of low experience level, and a second help line number may be displayed to users of a higher experience level as will be understood by persons of ordinary skill in the art. The first number may provide tutorials and general help, while the second number may be reserved for more complicated technical issues or user questions, for example. In some embodiments, a live video call may be initiated via the notification portion 184, such as by using voice over internet protocol (VoIP) technology, or other suitable methods, and such video conference may comprise screen sharing with a customer service agent and live help during the auction 134 for novice users. As will be appreciated, the video conference is desirably displayed on the auction page 148a such that the functionality and visibility of the bid mechanism 164 and the quick-buy mechanism 190 are not impaired thereby, and the user is able to bid in the auction 134 and purchase one or more bids or bids packs while receiving assistance from a customer service agent, for example.

In some exemplary embodiments, one or more of the above features of the information bar 170 may be omitted, as will be understood by persons of ordinary skill in the art presented in the instant disclosure. Any and all of the features of the information bar 170 described above are optional, and none are necessary for the functioning of the information bar 170 according to the instant inventive concept(s).

Referring now to FIGS. 6A-6B, shown therein is an exemplary embodiment of an auction page 148b comprising two or more auctions 134a-n and an information bar 170a. The information bar 170a may be implemented similarly to the information bar 170 described above, and may comprise a quick-buy mechanism 202 (FIG. 6B).

As shown in FIG. 6A, the two or more auctions 134a-n each comprise an auction item, an auction price, an auction timer and the bid mechanism 200. Further, the auction page 148b may comprise one or more auctions 134a-n that have ended, which ended auctions 134a-n indicate that the item has been sold by displaying “sold” or other similar indicator over a representation of the auction item, and replacing the bid mechanism 200 with an inactive sold icon 204 to indicate that the auction 134 has ended and the item has been sold, for example as shown in auctions 134a and 134b.

The auction page 148b is shown as comprising a plurality of auctions 134a-n, but it is to be understood that the number of auctions 134a-n may vary from one to infinity, for example. Further, auctions 134a-n that have ended may be displayed on the auction page 148b for a predetermined amount of time before being replaced with ongoing auctions 134a-n, for example, or may be removed from the auction page 148b as soon as they have ended, as will become apparent to persons of ordinary skill in the art presented with the instant disclosure.

Referring now to FIG. 6B, shown therein is the information bar 170a with the quick-buy portion 178a in its expanded state. The quick-buy portion comprises the quick-buy mechanism 202 and a bid-type selection mechanism 192a.

The bid type selection mechanism 192a is desirably implemented similarly to the bid type selection mechanism 192 described above, but may be implemented differently, or omitted from the quick-buy portion 178a, for example.

The quick-buy mechanism 202 is desirably implemented similarly to the quick-buy mechanism 190 described above, but may be implemented differently, provided that it functions substantially as described herein, for example.

As can be seen in FIG. 6B, the quick-buy mechanism 202 is shown as partially disrupting the visibility of the bid mechanism 200 of the auction 134d, and completely disrupting the visibility of the bid mechanism 200 of the auction 134e. Such configuration of the quick-buy mechanism 202 may be desirable in the embodiment of the auction page 148b, provided that the bid mechanism 200 of at least one of the two or more auctions 134 is at least partially visible and fully functional, for example. Provided that the bid mechanism 200 of at least one of the two or more auctions 134 is at least partially visible and fully functional, the quick-buy mechanism 202 may completely or partially disrupt, affect, or impair the visibility and/or functionality of one or more of the remaining auctions 134 displayed on auction page 148b, for example.

It is to be understood however, that in some exemplary embodiments of the auction page 148b, the quick-buy mechanism 202 may be selectively implemented such that no bid mechanisms 200 have their visibility and/or functionality affected thereby. Further, in some exemplary embodiments of the auction page 148b, the quick-buy mechanism 202 may be selectively implemented to impair the visibility of auctions 134 that have ended.

As will be appreciated by persons of ordinary skill in the art, the auction page 148b allows the user to participate in multiple auctions 134a-n simultaneously, and to observe one or more other auctions 134a-n from the same auction page 148b. Such auction page 148b allows the user to bid in one of the auctions 134a-n, bid in two of the auctions 134a-n, and bid in more than two of the auctions 134a-n. At the same time, the user may watch one or more auctions 134a-n without actively bidding in such auctions. Further, should the user run low on bids by virtue of bidding in multiple auctions 134a-n, the user may activate the quick-buy mechanism 202 to buy bids and continue bidding without missing a beat, or losing one of the auctions 134a-n due to inactivity, for example.

In an exemplary embodiment of the instant inventive concept(s), the functionality of the bid mechanism 200 and the quick-buy mechanism 202 may be combined in a single mechanism, which desirably functions as follows: When a user has zero remaining bids in their account, the selectable portion of the bid mechanism may be changed to indicate that a further activation of the bid mechanism 200 would comprise a purchase of at least one bid, and simultaneously would result in the at least one bid being placed in the auction 134. In one non-limiting example, if a user has zero remaining bids in their account and wishes to continue bidding, the user may activate such combined functionality by activating the bid mechanism 200, purchasing one or more bids (e.g. 25 bids), and placing a bid in the auction 134. In this example, the remaining bids (i.e., 24 bids) may be credited to the user's account and the bid mechanism 200 may resume the functionality described above. Further, in another non-limiting example, once the amount of bids in the user's account reaches zero, the user may activate such combined functionality by activating the bid mechanism 200, purchasing a single bid, and simultaneously placing that bid in the auction 134. Such step may be repeated as many times as desired by the user, as limited by the host system 102, until the auction 134 ends, or until the user has purchased one or more bids using the quick-buy mechanism 202, or a conventional bid purchase mechanism, for example.

In addition, in an exemplary embodiment of the instant inventive concept(s), some users may be assigned special status by the online auction system 100, such as an administrator, a super-user, a manager, and combinations thereof, for example. In the case of administrator-status users, options such as changing passwords and/or usernames of users, disabling user accounts, and other administrative options may be available to the user and may be shown in the user account/registration page.

From the above description, it is clear that the inventive concept(s) disclosed herein is adapted to carry out the objects and to attain the advantages mentioned herein as well as those inherent in the inventive concept(s) disclosed herein. While presently preferred embodiments of the inventive concept(s) disclosed herein have been described for purposes of this disclosure, it will be understood that numerous changes may be made which will readily suggest themselves to those skilled in the art and which are accomplished within the scope and spirit of the inventive concept(s) disclosed herein and defined by the appended claims.

What is claimed is:

1. An online auction system comprising:
a host system having at least one processor for executing processor executable code and at least one non-transitory memory communicating with the at least one processor and storing processor executable code, wherein the processor executable code when executed by the at least one processor, causes the at least one processor to:
transmit a first signal via a network to a user terminal indicative of a first auction page for auctioning an item, the first auction page comprising a bid mechanism and a quick-buy mechanism capable of being selectively activated by the user terminal;
receive a quick-buy signal from the user terminal over the network indicative of an activation of the quick-buy mechanism; and
in response to receiving the quick-buy signal, credit at least one bid to a user account, without disrupting a capability of the bid mechanism to be selectively activated by the user terminal.

2. The online auction system of claim 1, wherein the first auction page displays the bid mechanism and the quick-buy mechanism during the activation of the quick-buy mechanism by the user terminal.

3. An online auction system comprising:
a host system having at least one processor for executing processor executable code and at least one non-transitory memory communicating with the at least one processor and storing processor executable code and a user's account comprising a number of bids, wherein the processor executable code when executed by the at least one processor, causes the at least one processor to:
transmit a first signal over a network to a user terminal indicative of a first auction page for auctioning one or more items, the first auction page comprising one or more bid mechanisms and a quick-buy mechanism;
receive a bid signal from the user terminal over the network indicative of an activation of at least one of the one or more bid mechanisms by the user terminal;
in response to receiving the bid signal deduct a bid from the user's account;
in response to the number of bids remaining in the user account reaching a pre-set number, transmit a second signal over the network to the user terminal indicative of the number of bids remaining in the user account reaching the pre-set number;
receive a quick-buy signal from the user terminal over the network indicative of an activation of the quick-buy mechanism by the user terminal; and
in response to receiving the quick-buy signal, credit at least one bid to the user account, without disrupting the capability of at least one of the one or more bid mechanisms of being selectively activated by the user terminal.

4. The online auction system of claim 3, wherein the first auction page displays the bid mechanism and the quick-buy mechanism during the activation of the quick-buy mechanism by the user terminal.

5. The online auction system of claim 3, wherein the second signal contains information to cause the user terminal to provide at least one of a visual alert and an audible alert indicative of a number of bids remaining in the user account to the user.

6. An online auction system comprising:
a host system having at least one processor for executing processor executable code, and at least one non-transitory memory communicating with the at least one processor and storing processor executable code and a user's account comprising a number of bids, wherein the processor executable code when executed by the at least one processor, causes the at least one processor to:
transmit a first signal to a network indicative of a first auction page for auctioning an item, the first auction page comprising an auction price, a bid mechanism capable of being selectively activated by a user terminal, and a quick-buy mechanism capable of being selectively activated by the user terminal;
receive a second signal from the user terminal over the network indicative of an activation of the bid mechanism by the user terminal;
receive a third signal from the user terminal over the network indicative of an activation of the quick-buy mechanism by the user terminal;
in response to receiving the second signal, raise the auction price by a preset amount and deduct a bid from the user's account, without disrupting the capability of the quick-buy mechanism of being activated by the user terminal, such that the quick-buy mechanism remains at least partially visible to the user during the activation of the bid mechanism;
in response to receiving the third signal, credit at least one bid to the user's account, without disrupting the capability of the bid mechanism of being activated by the user terminal, such that the bid mechanism remains at least partially visible to the user during the activation of the quick-buy mechanism; and
transmit a fourth signal over the network to the user terminal, indicative of a raised auction price and an amount of bids remaining in the user's account.

7. An online auction system comprising:
a host system comprising at least one processor executing processor executable code and at least one non-transitory memory communicating with the at least one processor and storing processor executable code and a user's account comprising a number of bids, wherein the processor executable code when executed by the at least one processor, causes the at least one processor to:
transmit a first signal over a network to a user terminal indicative of a first auction page for auctioning one or more items, the first auction page comprising one or more bid mechanisms capable of being selectively activated by the user terminal;
receive a bid signal from the user terminal over the network indicative of an activation of the bid mechanism by the user terminal;
in response to receiving the bid signal deduct a bid from the user's account;
in response to the number of bids remaining in the user's account reaching a pre-set number, transmit a second signal over the network to the user terminal indicative of the first auction page comprising a quick-buy mechanism capable of being activated by the user;
receive a quick-buy signal from the user terminal over the network indicative of the activation of the quick-buy mechanism by the user terminal; and
in response to receiving the quick-buy signal, credit at least one bid to the user's account, without disrupting the capability of at least one of the one or more bid mechanisms of the first auction page of being activated by the user terminal.

8. An online auction system comprising:
a host system comprising at least one processor executing processor executable code and at least one non-transitory memory communicating with the at least one processor and storing processor executable code, wherein the processor executable code when executed by the at least one processor, causes the at least one processor to:
transmit a first signal via a network to a user terminal indicative of a first auction page for auctioning an item, the first auction page comprising a bid mechanism and an information bar having a quick-buy mechanism capable of being selectively activated by the user terminal;
receive a quick-buy signal from the user terminal over the network indicative of an activation of the quick-buy mechanism; and
in response to receiving the quick-buy signal, sell at least one bid to a user of the user terminal, without disrupting the capability of the bid mechanism of being selectively activated by the user terminal.

9. The online auction system of claim 8, wherein the information bar further comprises a social media hub having one or more links to one or more social media websites.

10. The online auction system of claim 8, wherein the information bar further comprises a connection meter portion indicating a speed of a connection between the host system and the user terminal.

11. The online auction system of claim 8, wherein the quick-buy mechanism further comprises a billing account selection mechanism and a bid amount selection mechanism adapted to allow the user to specify a billing account to be used and a number of bids to be purchased.

12. The online auction system of claim 8, wherein the information bar further comprising a watchlist portion adapted to allow the user to specify one or more auctions to be listed in the watchlist portion.

13. The online auction system of claim 8, wherein the information bar is adapted to be selectively toggled on and off by the user.

14. The online auction system of claim 8, wherein the information bar further comprises a notification portion for providing at least one of a visual alert and an audible alert to the user in response to a pre-set event.

15. The online auction system of claim 8, wherein the information bar is a horizontal bar.

16. The online auction system of claim 15, wherein the information bar is displayed at the bottom of the auction page.
